(19) United States
(12) Patent Application Publication
(10) Pub. No.: US 2008/0128930 A1
(43) Pub. Date: Jun. 5, 2008

(54) Method of Releasing Contact Lens

(76) Inventors: Yu-Chin Lai, Pittsford, NY (US); Gary D. Friends, Ontario, NY (US); Mary Lou Friends, Ontario, NY (US)

Correspondence Address: Bausch & Lomb Incorporated, One Bausch & Lomb Place, Rochester, NY, 14604-2701, US

(21) Appl. No.: 11/943,052

(22) Filed: Nov. 20, 2007

Related U.S. Application Data
(60) Provisional application No. 60/868,195, filed on Dec. 1, 2006.

(51) Int. Cl. B29D 11/00

(52) U.S. Cl. 264/2.6; 264/1.1

(57) ABSTRACT

A method of making a contact lens involves adding a lens-forming mixture to a contact lens mold, copolymerizing the lens-forming monomers to form a contact lens, releasing the contact lens from the mold; and removing the polymeric material from the contact lens. The polymeric material is not reactive with the lens-forming monomers, but is included in the lens-forming monomer mixture to facilitate releasing the contact lens from the mold.

### CROSS-REFERENCE

This application claims the benefit of Provisional Patent Application No. 60/868,195 filed Dec. 1, 2006, which is incorporated by reference herein.

### BACKGROUND OF THE INVENTION

Hydrogels represent a desirable class of materials for the manufacture of various biomedical devices, including contact lenses. A hydrogel is a hydrated cross-linked polymeric system that contains water in an equilibrium state. Hydrogel lenses offer desirable biocompatibility and comfort. A silicone hydrogel is a hydrogel material including a silicone-containing monomer, the silicone containing monomer imparting higher oxygen permeability to the resultant hydrogel copolymer.

In a typical process for the manufacture of hydrogel polymeric ophthalmic devices, such as contact lenses, a composition containing a mixture of lens-forming monomers is charged to a mold and cured to polymerize the lens-forming monomers and form a shaped article. In the case where the mold is a two-part mold assembly, including an anterior mold half and a posterior mold half, one of these mold halves is removed, with the cast contact lens remaining adhered to the other mold half. The contact lens may be released from this mold half by either a wet release process or a dry release process. In a wet release process, the lens is subjected to water or an aqueous solution so that it swells upon absorbing water and is released from the mold. In a dry release process, the lens is released from the mold in a dry state and without adding aqueous media, such as by mechanical actions. Following release of the contact lens from the mold, the lens is subjected to various downstream processes, such as inspection, packaging and sterilization.

A description of various stages in casting lenses is provided in U.S. Pat. No. 5,271,875 (Appleton et al.), including dry release from the mold.

The present invention recognized that if the cured contact lens is too soft, dry release from the contact lens mold may be difficult. In other words, the contact lens adheres to the mold, and because the contact lens is soft, mechanical manipulation of the lens and/or mold does not effect release reliably. This is particularly true for various silicone hydrogel contact lenses, since silicone-containing monomers tend to render the resultant copolymer softer and with a lower modulus. Also, in many cases, the lens-forming monomer mixture may further include a non-reactive diluent, typically a lower molecular weight, non-polymeric organic compound, which remains in the resulting polymerized contact lens. Such diluents may also tend to soften the resultant cured contact lens.

### SUMMARY OF THE INVENTION

This invention solves the aforementioned problems by providing a method for more reliable release of a contact lens from its mold, resulting in improved yields and a more efficient manufacturing process.

In a first aspect, the method comprises:

adding a lens-forming mixture to a contact lens mold, said mixture comprising lens-forming monomers reactive with one another and a polymeric material not reactive with the lens-forming monomers;

copolymerizing the lens-forming monomers to form a contact lens;

releasing the contact lens from the mold; and

removing the polymeric material from the contact lens.

In a second aspect, the method comprises sequentially:

adding a lens-forming mixture to a contact lens mold, said mixture comprising lens-forming monomers reactive with one another and a polymeric material not reactive with the lens-forming monomers;

copolymerizing the lens-forming monomers to form a contact lens;

releasing the contact lens from the mold;

removing the polymeric material from the contact lens; and

hydrating, packaging and sterilizing the contact lens.

### DETAILED DESCRIPTION OF VARIOUS PREFERRED EMBODIMENTS

This invention is applicable to various contact lens materials, especially hydrogels. A hydrogel is a crosslinked polymeric system that can absorb and retain water in an equilibrium state. The monomeric mixtures employed in the invention include conventional lens-forming monomers, especially monomers including ethylenic unsaturation that are copolymerizable with one another by free radical polymerization. (As used herein, the term “monomer” or “monomeric” and like terms denote relatively low molecular weight compounds that are polymerizable by free radical polymerization, as well as higher molecular weight compounds also referred to as “prepolymers”, “macromonomers”, and related terms.)

This invention is especially applicable for silicone-containing hydrogels, i.e., the hydrated polymerization product of a monomer mixture comprising a silicone-containing lens-forming monomer and a hydrophilic lens-forming monomer.

A first class of silicone-containing monomers are polysiloxane-containing prepolymers endcapped with polymerizable ethylenically unsaturated radicals.

The term “polysiloxane-containing” denotes that the prepolymer includes polysiloxane-containing soft segments. These segments are preferably derived from polysiloxanes endcapped with hydroxyl or amino radicals and represented by the following formula (PS′):

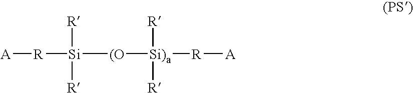

wherein each A is a hydroxyl or amino radical;

each R is independently selected from an alkylene group having 1 to 10 carbon atoms wherein the carbon atoms may include ether, urethane or urea linkages therebetween;

each R′ is independently selected from hydrogen, monovalent hydrocarbon radicals or halogen substituted monovalent hydrocarbon radicals wherein the hydrocarbon radicals have 1 to 20 carbon atoms which may include ether linkages therebetween, and

a is at least 1.

Preferred R radicals are alkylene optionally substituted with ether radicals. Preferred R′ radicals include: alkyl groups, phenyl groups, fluoro-substituted alkyl groups and alkenyl groups, optionally substituted ether groups. Especially preferred R′

radicals include: alkyl, such as methyl; or fluoroalkyl optionally including ether linkages, such as —CH₂—CH₂—CH₂—O—CH₂—(CF₂)_{z}—H where z is 1 to 6.

Preferably, a is about 10 to about 100, more preferably about 15 to about 80. The Mn of PS′ ranges from 1000 to 8000, more preferably 2000 to 6000.

Various polysiloxane-diols and polysiloxane-diamines are commercially available. Additionally, representative syntheses of polysiloxanes are provided in the Examples.

The term “prepolymer endcapped with polymerizable ethylenically unsaturated radicals” denotes that the prepolymer is polymerizable and is endcapped with the ethylenically unsaturated radicals. The prepolymers are endcapped at both ends with a polymerizable ethylenically unsaturated radical. Preferred terminal polymerizable radicals are represented by formula (M′):

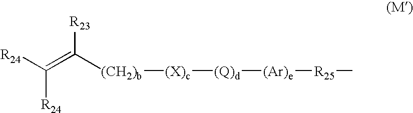

wherein:

R₂₃ is hydrogen or methyl;

each R₂₄ is hydrogen, an alkyl radical having 1 to 6 carbon atoms, or a —CO—Y—R₂₆ radical wherein Y is —O—, —S— or —NH—;

R₂₅ is a divalent alkylene radical having 1 to 10 carbon atoms;

R₂₆ is a alkyl radical having 1 to 12 carbon atoms;

Q denotes —CO—, —OCO— or —COO—;

X denotes —O— or —NH—;

Ar denotes an aromatic radical having 6 to 30 carbon atoms; b is 0 to 6; c is 0 or 1; d is 0 or 1; and e is 0 or 1. Suitable endcapping precursors, for forming the M radicals, include: hydroxy-terminated (meth)acrylates, such as 2-hydroxyethylmethacrylate, 2-hydroxyethylacrylate, and 3-hydroxypropylmethacrylate; and amino-terminated (meth)acrylates, such as t-butylaminoethylmethacrylate and aminoethylmethacrylate; and (meth)acrylic acid. (As used herein, the term “(meth)” denotes an optional methyl substituent. Thus, terms such as “(meth)acrylate” denotes either methacrylate or acrylate, and “(meth)acrylic acid” denotes either methacrylic acid or acrylic acid.)

One class of polysiloxane prepolymers comprises blocks (I) and (II) and is terminated at each end with an ethylenically unsaturated radical:

(*Dii*Diol*Dii*PS)ₓ (I)

(*Dii*PS)_{y} (II)

wherein:

each Dii is independently a diradical residue of a diisocyanate;

each Diol is independently a diradical residue of a diol having 1 to 10 carbon atoms;

each PS is independently a diradical residue of a polysiloxane-diol or -diamine

(i.e., the diradical residue of PS′, where A would be —O— or —NH—);

each * is independently —NH—CO—NH—, —NH—COO— or —OCO—NH—:

x represents the number of blocks (I) and is at least 2, and

y represents the number of blocks (II) and is at least 1.

This class of prepolymers includes those represented by the general formulae:

M(*Dii*Diol*Dii*PS)ₓ(*Dii*PS)_{y}*Dii*M (III) or

M(*Dii*Diol*Dii*PS)ₓ(*Dii*PS)_{y}*Dii*Diol*Dii*M (IV)

wherein Dii, Diol, PS, PS′, *, x and y are as defined above, and M is a polymerizable ethylenically unsaturated radical.

Generally, the blocks of formula (I) may be characterized as composed of strong hard segments (represented by *Dii*Diol*Dii*) and soft segments (represented by PS). Generally, the blocks of formula (II) may be characterized as composed of weaker hard segments (represented by *Dii*) and soft segments (represented by PS). The distribution of these weaker and strong hard blocks (I) and (II) may be random or alternate, where x and y represent the total number of blocks of respective structures in the prepolymer; stated differently, it is not necessary in formulae (III) and (IV) that all blocks of formula (I) are directly linked to each other. The distribution of these blocks may be controlled by the sequence of addition of the polysiloxane, diisocyanate and short chain diol ingredients during the preparation of the prepolymer.

The prepolymers include polysiloxane-containing soft segments, represented by PS in formulae (I), (II), (III) and (IV). More particularly, this polysiloxane-containing segment is derived from polysiloxanes endcapped with hydroxyl or amino radicals, such as polysiloxane segments represented by formula (PS′).

Preferably, a in formula (III) and (IV) is about 10 to about 100, more preferably about 15 to about 80. The Mn of PS ranges from 1000 to 8000, more preferably 2000 to 6000.

The strong hard segments of the prepolymers include the residue of a diol, represented by Diol in formulae (I), (III) and (IV). Preferred Diol radicals include the diradical residue of an alkyl diol, a cycloalkyl diol, an alkyl cycloalkyl diol, an aryl diol or an alkylaryl diol having 1 to 10 carbon atoms and which may contain ether, thio or amine linkages in the main chain. Representative diols include 2,2-(4,4′-dihydroxydiphenyl)propane (bisphenol-A), 4,4′-iso-propylidine dicyclohexanol, ethoxylated, and propoxylated bisphenol-A, 2,2-(4,4′-dihydroxydiphenyl)pentane, 1,1′-(4,4′-dihydroxydiphenyl)-p-diisopropyl benzene, 1,3-cyclohexane diol, 1,4-cyclohexane diol, 1-4-cyclohexane dimethanol, neopentyl glycol, 1,4-butanediol, 1,3-propanediol, 1,5-pentanediol, ethylene glycol, diethylene glycol and triethylene glycol. Especially preferred are alkylene and etherified alkylene diols having 1 to 10 carbon atoms.

The aforementioned polysiloxane-containing segments and diol residue segments are linked via diisocyanates that react with hydroxyl- or amino-functionality of the polysiloxane-containing segments and diols. Generally, any diisocyanate may be employed. These diisocyanates may be aliphatic or aromatic, and include alkyl, alkyl cycloalkyl, cycloalkyl, alkyl aromatic and aromatic diisocyanates preferably having 6 to 30 carbon atoms in the aliphatic or aromatic moiety. Specific examples include isophorone diisocyanate, hexamethylene-1,6-diisocyanate, 4,4′-dicyclohexylmethane diisocyanate, toluene diisocyanate, 4,4′-diphenyl diisocyanate, 4,4′-diphenylmethane diisocyanate, p-phenylene diisocyanate, 1,4-phenylene 4,4′-diphenyl diisocyanate, 1,3-bis-(4,4′-isocyanto methyl)cyclohexane, and cyclohexane diisocyanate.

Generally, higher x values results in prepolymers have a higher number of polar urethane/urea linkages, and polarity of the prepolymer is important to ensure compatibility with hydrophilic co-monomers. Generally, higher y values results in prepolymers with a higher percentage of silicone, resulting in higher oxygen permeability. However, the ratio of x and y should be balanced. Accordingly, the ratio of x to y is preferably at least 0.6 (i.e., x:y is at least 0.6:1), more preferably at least 0.75.

The prepolymers are endcapped at both ends with a polymerizable ethylenically unsaturated radical, represented by M in formulae (III) and (IV). Representative M radicals are represented by formula (M′).

A first representative reaction scheme for forming the prepolymers is as follows. First, a diisocyanate is reacted with a diol, at a molar ratio of 2:1, respectively.

2×OCN-Dii-NCO+xHO-Diol-OH→xOCN-Dii*Diol*Dii-NCO

In this scheme, * designates a urethane radical —NH—COO— or —OCO—NH—. Generally, this reaction is conducted in the presence of a catalyst, such as dibutyl tin dilaurate and in a solvent, such as methylene chloride, and under reflux. Then, a diisocyanate and the polysiloxane-diol are added, with the ratio of total diisocyanates (x+y) to polysiloxane-diol being at least 1.1. (Generally, 2<x+y≦11; x>0; y>0.)

xOCN-Dii-*-Diol-*-Dii-NCO+(x+y−1)HO—PS—OH+yOCN-Dii-NCO→OCN-(Dii*Diol*Dii*PS)ₓ(*Dii*PS)_{y}*Dii-NCO

Finally, this product is endcapped with the polymerizable ethylenically unsaturated radical.

OCN-(Dii*Diol*Dii*PS)ₓ(*Dii*PS)_{y}*Dii-NCO+2M-OH→M(*Dii*Diol*Dii*PS)ₓ(*Dii*PS)_{y}*Dii*M

A second representative reaction scheme for forming the prepolymers of formula (I), (II), (III) and/or (IV) is as follows. First, a diisocyanate is reacted with the polysiloxane-diol at a molar ratio shown below, where (1+1/m) preferably ranges from 1.05 to 1.9, most preferably from 1.2 to 1.5.

(m+1)OCN-Dii-NCO+mHO—PS—OH→OCN-(Dii*PS)ₘ*Dii-NCO

In this scheme, * again designates a urethane radical —NH—COO— or —OCO—NH—. Generally, this reaction is conducted in the presence of a catalyst, such as dibutyl tin dilaurate and in a solvent, such as methylene chloride, and under reflux. Then, the diol is added, with the molar ratio selected based on the desired ratio of strong and weak hard segments, with reflux continued, where z1/z2 is equal to or lower than 2 but higher than 1.

z1OCN-(Dii-*-PS)ₘ-*-Dii-NCO+z2HO-Diol-OH→OCN-Dii*Diol*Dii*PS)ₓ(*Dii*PS)_{y}*Dii-NCO

Finally, this product is endcapped with the polymerizable ethylenically unsaturated radical.

OCN-Dii*Diol*Dii*PS)ₓ(*Dii*PS)_{y}*Dii-NCO+2M-OH→M(*Dii*Diol*Dii*PS)ₓ(*Dii*PS)_{y}*Dii*M

In the above reaction schemes, the reaction of diols with diisocyanates yields urethane radicals (—NH—COO— or —OCO—NH—). Alternatively, the reaction of diamines with diisocyantes would yield urea radicals (—NH—CO—NH—). Other methods for forming urethane or urea polymers are known in the art.

A second class of polysiloxane prepolymers are represented by the formula:

M(*Dii*PS)ₓ*Dii*M (V)

wherein:

Dii, PS, * and M have the same meanings as above. Generally, the *Dii*PS blocks of formula (I) may be characterized as composed of relatively weak hard segments (represented by *Dii*) and soft segments (represented by PS). In formula (V), x is at least two, more preferably at least three.

A representative reaction scheme for forming this class of prepolymers is as follows. First, a diisocyanate is reacted with the polysiloxane-diol.

(n+1)OCN-Dii-NCO+nHO—PS—OH→OCN-(Dii*PS)x*Dii-NCO

In this scheme, * designates a urethane radical —NH—COO— or —OCO—NH—. Generally, this reaction is conducted in the presence of a catalyst, such as dibutyl tin dilaurate and in a solvent, such as methylene chloride, and under reflux. Finally, this product is endcapped with the polymerizable ethylenically unsaturated radical.

OCN-(Dii*PS)x*Dii-NCO+2M-OH→M(*Dii*PS)ₓ*Dii*M

In the above reaction scheme, the reaction of the polysiloxane-diol with the diisocyanate yields urethane radicals (—NH—COO— or —OCO—NH—). Alternatively, the reaction of poly-siloxane-diamines with diisocyanates would yield urea radicals (NH—CO—NH—). Other methods for forming urethane or urea polymers are known in the art.

Additional polysiloxane-containing prepolymers are represented by the formulae:

M(*Dii*PS*Dii*Diol)ₓ*Dii*PS*Dii*M (VI)

M(*Dii*Diol*Dii*PS)ₓ*Dii*Diol*Dii*M (VII)

where Dii, PS, Diol, * and Dii have the same meanings as above. In formulae (VI) and (VII), x is at least one. Generally, these prepolymers are composed of alternating strong hard segments (represented by *Dii*Diol*Dii*) and soft segments (represented by PS). These prepolymers may be prepared by methods generally known in the art, including the general methods disclosed in U.S. Pat. No. 5,034,461 (Lai et al.), the entire disclosure of which is incorporated herein by reference.

A further class of polysiloxane prepolymers are represented by the formula:

M(*PS*Dii)_{x′}*PS*M (VIII)

wherein:

Dii, PS, * and M have the same meanings as above, and x′ is zero or an integer of at least one. Generally, the *PS*Dii blocks of formula (I) may be characterized as composed of relatively weak hard segments (represented by *Dii*) and soft segments (represented by PS).

A representative reaction scheme for forming this class of prepolymers is as follows. First, a diisocyanate is reacted with the polysiloxane-diol.

(n)OCN-Dii-NCO+(n+1)HO—PS—OH→H—(PS*Dii)x′*PS—H

In this scheme, * designates a urethane radical —NH—COO— or —OCO—NH—. Generally, this reaction is conducted in the presence of a catalyst, such as dibutyl tin dilaurate and in a solvent, such as methylene chloride, and under reflux. Finally, this product is endcapped with the polymerizable ethylenically unsaturated radical.

H—(PS*Dii)x′*PS—H+2M-NCO→M(*PS*Dii)_{x′}*PS*M

In the above reaction scheme, the reaction of the polysiloxane-diol with the diisocyanate yields urethane radicals (—NH—COO— or —OCO—NH—). Alternatively, the reaction of poly-siloxane-diamines with diisocyanates would yield urea radicals (NH—CO—NH—). Other methods for forming urethane or urea polymers are known in the art.

Preferably, the prepolymer has a molecular weight (Mn) of at least 10,000, more preferably at least 15,000, and most preferably at least 20,000. Preferably, the prepolymer has a silicon atom content of at least 25 weight % of the prepolymer, more preferably at least 30 weight %.

Additional examples of polysiloxane prepolymers include the following:

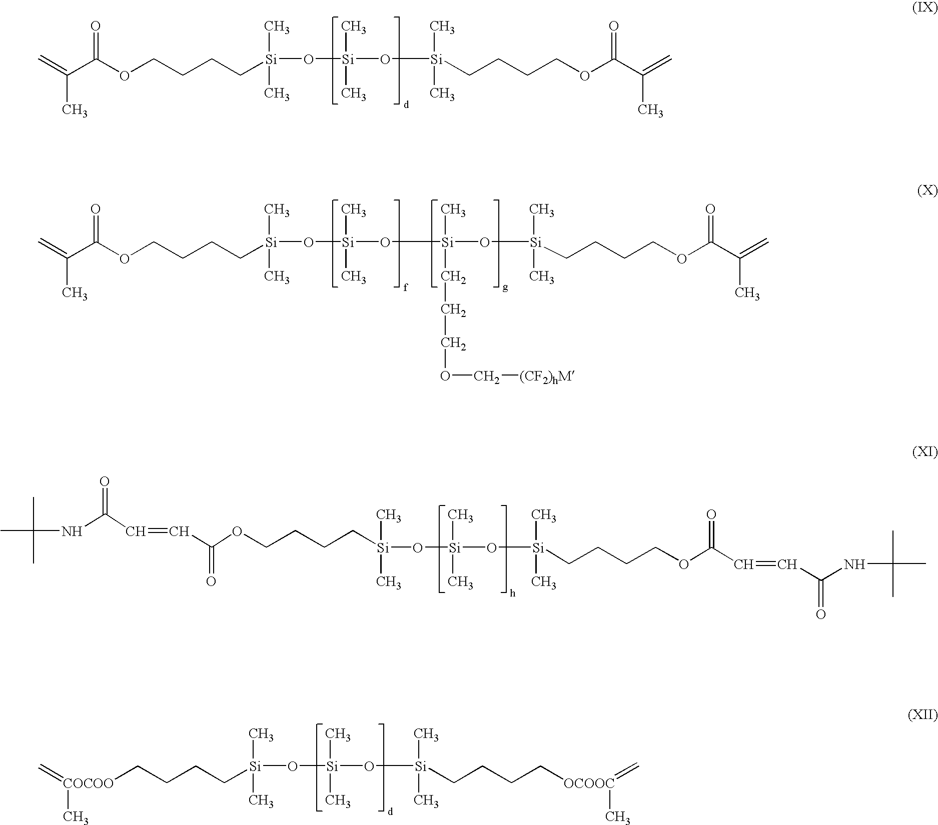

wherein:

d, f, g and k range from 0 to 250, preferably from 2 to 100; h is an integer from 1 to 20, preferably 1 to 6; and

M′ is hydrogen or fluorine.

Another suitable class of silicone-containing monomers include known bulky, monofunctional polysiloxanylalkyl monomers represented by Formula (XIII):

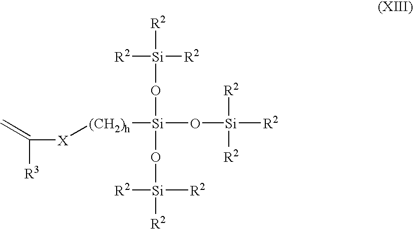

X denotes —COO—, —CONR⁴—, —OCOO—, or —OCONR⁴— where each where R⁴ is H or lower alkyl; R³ denotes hydrogen or methyl; h is 1 to 10; and each R² independently denotes a lower alkyl or halogenated alkyl radical, a phenyl radical or a radical of the formula

—Si(R⁵)₃

wherein each R⁵ is independently a lower alkyl radical or a phenyl radical. Such bulky monomers specifically include methacryloxypropyl tris(trimethylsiloxy)silane (TRIS), pentamethyldisiloxanyl methylmethacrylate, tris(trimethylsiloxy) methacryloxy propylsilane, methyldi(trimethylsiloxy)methacryloxymethyl silane, 3-[tris(trimethylsiloxy)silyl]propyl vinyl carbamate, and 3-[tris(trimethylsiloxy)silyl]propyl vinyl carbonate.

Various other difunctional and multifunctional silicone-containing monomers are known in the art and may be used as a lens-forming comonomer if desired.

Generally, the initial monomer mixture includes silicone-containing monomers at 5 to 95 weight percent, preferably 20 to 70 weight percent, of the total weight of the mixture.

At least one hydrophilic comonomer is combined with the silicone-containing monomer in the initial monomeric mixture. Representative hydrophilic monomers include: unsaturated carboxylic acids, such as methacrylic and acrylic acids; (meth)acrylic substituted alcohols, such as 2-hydroxyethylmethacrylate, 2-hydroxyethylacrylate and glyceryl methacrylate; vinyl lactams, such as N-vinyl pyrrolidone; and (meth)acrylamides, such as methacrylamide and N,N-dimethylacrylamide. Generally, at least one hydrophilic monomer is included in the monomer mixture at 20 to 60 weight percent, preferably 25 to 50 weight percent, of the total weight of the mixture.

The monomer mixture includes a crosslinking monomer (a crosslinking monomer or crosslinker being defined as a monomer having multiple polymerizable functionalities). In the case where the silicone-containing monomer is a prepolymer endcapped at both ends with a polymerizable radical, these prepolymers will function as a crosslinker. Optionally, a supplemental crosslinking monomer may be added to the initial monomeric mixture. Representative crosslinking monomers include: divinylbenzene, allyl methacrylate, ethyleneglycol dimethacrylate, tetraethyleneglycol dimethacrylate, polyethyleneglycol dimethacrylate, vinyl carbonate derivatives of the glycol dimethacrylates, and methacryloxyethyl vinylcarbonate. When a supplemental crosslinking agent is employed, this monomeric material may be included in the monomer mixture at 0.1 to 20 weight percent, more preferably at 0.2 to 10 weight percent.

An organic diluent may be included in the initial monomeric mixture. As used herein, the term “organic diluent” encompasses organic compounds that are substantially unreactive with the components in the initial mixture, and are often used to minimize incompatibility of the monomeric components in this mixture. Representative organic diluents include non-polymeric materials such as: monohydric alcohols, such as C₂-C₁₀ monohydric alcohols; diols such as ethylene glycol; polyols such as glycerin; ethers such as diethylene glycol monoethyl ether; ketones such as methyl ethyl ketone; esters such as methyl heptanoate; and hydrocarbons such as toluene. It is preferred, however, that the diluent is employed in amounts no higher than 20 weight percent, based on total weight of the monomer mixture.

The monomer mixture may further include minor amounts of a polymerization imitator, especially a UV or visible light initiator, a tint, and a UV blocking agent, each of which are known in the art.

In forming lenses or other biomedical devices, the liquid lens-forming monomer mixtures are charged to a mold having a molding surface with a desired shape, and then cured (or polymerized) while in the mold. Curing may be effected by subjecting the monomer mixture in the mold to heat or to light radiation, such as UV radiation or visible light, to effect free radical polymerization. Various processes are known for curing a monomeric mixture in the production of contact lenses or other biomedical devices, including spincasting and static casting. Spincasting of contact lenses involves charging the monomer mixture to a mold having a concave, lens-shaped molding surface, and spinning the mold in a controlled manner while exposing the monomer mixture to light. Static casting methods involve charging the monomer mixture between two mold sections forming a mold cavity providing a desired lens shape, and curing the monomer mixture by exposure to heat and/or light. In the case of contact lenses, one mold section has a mold surface shaped to form the anterior lens surface and the other mold section has a mold surface shaped to form the posterior lens surface. Such methods are described in U.S. Pat. Nos. 3,408,429, 3,660,545, 4,113,224, 4,197,266, 5,271,875, and 5,260,000, the disclosures of which are incorporated herein by reference.

Following casting, the contact lens is removed from the mold. In the case where the mold is a two-part mold assembly, including a posterior mold half and an anterior mold half, one of these mold halves is removed, with the cast contact lens remaining adhered to the other mold half. In many processes, it is desired that the contact lens remains with the anterior mold half. The contact lens is released from this mold half by a dry release process, i.e., the lens is released from the mold half in a dry state and without adding aqueous media, such as by mechanical actions. Following release of the contact lens from the mold, the lens is subjected to various downstream processes, such as inspection, packaging and sterilization. Various other optional processes may be employed, for example, the lens may be machined to provide a contact lens or article having a desired final configuration.

In this invention, a polymeric material not reactive with the lens-forming monomers is added to the lens-forming monomer mixture, prior to curing the mixture to form a contact lens, i.e., prior to copolymerizing the lens-forming monomers in the mold to form a contact lens. This polymeric material serves to stiffen the resultant cured contact lens, thus making it easier to dry release from the mold.

The polymeric material has a glass transition temperature of at least 80° C., more preferably at least 100° C. The glass transition of the polymeric material may be contrasted with a cured, unhydrated contact lens, which typically has a glass transition temperature ranging from −50 to 50° C.

The polymeric material is preferably miscible with the lens-forming monomers, and is preferably soluble in the lens-forming monomers. Accordingly, so that the polymeric material and the lens-forming monomers are miscible with each other, preferred polymeric materials are derived from monomers similar to those employed as lens-forming monomers.

As an example, silicone hydrogel lenses, as mentioned previously, are formed from a silicone-containing lens forming monomer and a hydrophilic monomer. Thus, a preferred polymeric material for addition to the monomer mix is a polymer based on a similar silicone-containing monomer, or a copolymer of such a silicone-containing monomer and a hydrophilic monomer.

As a further example, in the case where methacryloxypropyl tris(trimethylsiloxy)silane (TRIS) is employed as a lens-forming monomer, a polymer of TRIS, or a copolymer of TRIS and a hydrophilic monomer such as DMA or NVP, may be used as the polymeric material added to the monomer mix. In the case where 3-[tris(trimethylsiloxy)silyl]propyl vinyl carbamate (TRIS-VC) is employed as a lens-forming monomer, a polymer of TRIS-VC, or a copolymer of TRIS-VC and a hydrophilic monomer such as NVP may be used as the polymeric material added to the monomer mix.

These illustrative polymers, derived solely from DMA, NVP, TRIS and/or TRIS-VC, are all very stiff and have a high glass transition temperature (T_{g}). As an example, homopolymers derived from each of these monomers, have T_{g} of at least 80° C. For example, poly(DMA) has a T_{g} of 89° C. and poly(NVP) has a T_{g} of 170° C.

Since the polymer (or copolymer) of TRIS or TRIS-VC has already been polymerized, prior to adding to the lens-forming monomer mix, the polymer no longer contains significant ethylenic groups for reaction with the lens-forming monomers. In other words, this polymeric material lacks ethylenic unsaturation.

Additionally, in order to improve the miscibility of the polymeric material with the lens-forming monomers, it is preferred the molar ratio of the monomers used for making the polymeric material matches closely the ratio of the similar monomers in the lens-forming monomer mixture. By employing a polymeric material miscible with the lens-forming monomer mixture, the monomer mix and the resultant lens cast from the monomer mixture are less likely to appear cloudy or hazy.

Additional examples of specific polymeric materials are included in the Examples. Preferably, the polymeric material is included in the lens-forming mixture at 1 to 25 weight percent of the polymeric material based on total weight of the lens-forming mixture, more preferably at 5 to 20 weight percent. Generally, it will be desirable to employ the minimal amount of polymeric material, i.e., the minimal amount to raise the modulus of lens sufficient to effect dry release of the contact lens from its mold.

Stated differently, higher T_{g} polymeric materials are more glass-like, and much stiffer than lower T_{g} materials. By adding the higher T_{g} polymeric material to the lens-forming monomer mixture, the resultant contact lens will have a greater stiffness than a contact lens prepared from the same lens-forming monomer mixture but lacking the higher T_{g} polymeric material. This invention recognized that if contact lenses, especially silicone hydrogel contact lenses, are too soft, they tend to stick with the contact lens mold halves, especially the posterior mold half. By increasing the stiffness of the lenses, the lenses are easier to remove from the mold half, and, in fact, tend to remain with the anterior mold half. The contact lenses can be demolded easily from the anterior mold half by a dry release process, i.e., without the need for an aqueous media to release the lens from the mold.

Prior to sealing the contact lens in a package, and after the lens is released from the mold, the lens is extracted with an aqueous or an organic media to remove the polymeric material therefrom. Extraction also serves to remove any of the lens-forming monomers that may not be fully polymerized, or oligomers formed from side reactions of the lens-forming monomers, these unreacted monomers or oligomers remaining in the polymeric article. Hydrophilic residual materials can be extracted by water or aqueous solutions, whereas hydrophobic residual materials generally involve extraction with an organic solvent. One common organic solvent currently used for extraction of contact lenses is isopropanol, a water-miscible organic solvent. An example of such a process for silicone hydrogel contact lenses is found in U.S. Pat. No. 5,260,000 (Nandu) et al., where silicone hydrogel contact lenses are cast from monomeric mixtures including n-nonanol or n-hexanol as a diluent, and subsequently extracted with isopropanol to remove the diluent as well as unreacted monomers and oligomers. As stated previously, in this invention the extraction serves to also remove the polymeric material. Removal of the higher T_{g} polymeric material reduces the stiffness of the resultant contact lens to a lower level that is more desirable for contact lens wear.

In the case of silicone hydrogels, a preferred extractant is an organic solvent, such as a lower alkanol. Other suitable extractants include diethylene glycol monomethyl ether, diethylene glycol monoethyl ether, diethylene glycol monopropyl ether, diethylene glycol monobutyl ether, diethylene glycol monovinyl ether, and 3-methoxy-1-butanol.

Following extraction, a hydrogel contact lens is hydrated by soaking in water or an aqueous solution, which may also serve to replace any organic extractant, used for extraction, with water.

The following examples illustrate various preferred embodiments of this invention. The following abbreviations are used in the illustrative examples:

TRIS—methacryloxypropyl tris(trimethylsiloxy)silane

TRIS-VC—3-[tris(trimethylsiloxy)silyl]propyl vinyl carbamate

NVP—N-vinyl pyrrolidone

DMA—N,N-dimethylacrylamide

HEMA—2-hydroxyethyl methacrylate

HEMA-VC—methacryloxyethyl vinyl carbonate

IMVT—1,4-bis[4-(2-methacryloxyethyl)phenylamino]anthraquinone

I5S4H—a urethane-containing polysiloxane prepolymer derived from isophorone diisocyanate (IPDI), a hydroxybutyl-terminated polydimethylsiloxane (HBPDMS) of Mn 4,000, and end capped with 2-hydroxyethyl methacrylate (HEMA), with the feed molar ratio of IIPDI:HBPDMS at 6:5:2

V₂D₂₅—a prepolymer of formula (XII) where d is about 25

V₂D₉₀F₁₀—a compound of the following formula, where n is approximately 90 and n′ is approximately 10:

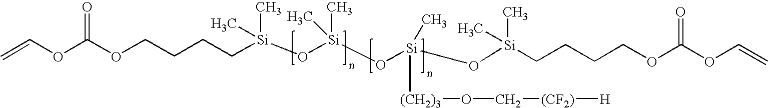

### Example 1

### Preparation of Polymeric Material

### TRIS/DMA at Molar Ratio 1:1

A 3-neck, 1-L dried round bottom flask was charged with 42.34 g (0.100 mole) of TRIS, 9.91 g (0.100 mole) of DMA, and 200 mL of dry THF. The contents were bubbled with argon for 30 minutes. Then Vazo-64 initiator (0.2688 g) was added and the contents were refluxed overnight under argon, then dried under nitrogen for three days. The product was recovered after removal of solvent under vacuum. Yield was quantitative. SEC shows: Mn 17,995; Mw 41,032; Pd=2.28.

### Example 2

### Preparation of Polymeric Material

### TRIS/DMA at Molar Ratio 0.7:1

A 3-neck, 500-mL dried round bottom flask was charged with 20.053 g (0.0475 mole) of TRIS, 0.49 mL of mercaptoethanol, 6.54 g (0.066 mole) of DMA, and 90 mL of dry THF. The contents were bubbled with nitrogen for 15 minutes. Then Vazo-64 initiator (0.142 g) was added and the contents were refluxed overnight under nitrogen. IR spectrum showed no vinyl (1620 cm-1) remaining. The solution was poured into ether to precipitate the product, and the product was dried in an oven at 60° C. Yield was quantitative. SEC shows: Mn over 3500; Mn over 7000.

### Example 3

### Preparation of Polymeric Material

### Tris-Vc/Nvp at Molar Ratio 0.7:1

A 3-neck, 500-mL dried round bottom flask is charged with 20.053 g (0.0475 mole) of TRIS-VC, 0.49 mL of mercaptoethanol, 7.33 g (0.066 mole) of NVP and 90 mL of dry THF. The contents are bubbled with nitrogen for 15 minutes. Then Vazo-64 initiator (0.142 g) is added and the contents are refluxed overnight under nitrogen. IR spectrum is conducted to confirm no vinyl (1620 cm⁻¹) remaining. The solution is poured into ether to precipitate the product, and the product is then dried in an oven at 60° C.

### Measurements of Glass Transition Temperatures

Glass transition temperatures are measured by using a differential scanning calorimeter. The glass transition temperatures of polymers of Examples 1-3, by this method, are expected to be above 100° C.

### Example 4

### Contact Lens Casting

A monomer mixture was prepared by mixing the following components, with parts by weight or parts per million designated parenthetically: 15S4H (60 pbw); TRIS (15 pbw); DMA (15 pbw); HEMA (2 pbw); NVP (12 pbw); HEMA-VC (0.5 pbw); n-hexanol (10 pbw); Darocur-1173 initiator (0.5 pbw); IMVT (150 ppm); and the TRIS-DMA copolymer of Example 1 (5 pbw). The mixture was slightly hazy. The mixture was added to a two-part polypropylene mold assembly and cured under UV light for 1 hour. After separating the posterior and anterior mold halves, all lenses remained with the anterior mold half.

### Example 5

### Film Casting

The same monomer mixture as in Example 4 was cured between two silane-treated glass plates under UV light for 2 hours. After removing the nonanol diluent under vacuum in an oven, the films were tested for modulus. Modulus tests were conducted according to ASTM D-1708a, employing an Instron (Model 4502) instrument where the hydrogel film sample is immersed in borate buffered saline; an appropriate size of the film sample is gauge length 22 mm and width 4.75 mm, where the sample further has ends forming a dogbone shape to accommodate gripping of the sample with clamps of the Instron instrument, and a thickness of 200±50 microns. Modulus of the films was 3213+/−305 g/mm².

### Comparative Example 1

Contact lenses were cast from a comparable monomer mixture as that in Example 4, except no TRIS-DMA copolymer was used. After separating the posterior and anterior mold halves, 66% of the lenses stayed with the anterior mold half, and 33% of the lenses stayed with the posterior mold half.

Films were also prepared as in Example 5, except the monomer mixture lacked the TRIS-DMA copolymer. The films, after removal of nonanol, had a modulus of 2865+/−194 g/mm².

These data suggest, with the addition of 5% pbw of the DMA-TRIS copolymer, the lenses were stiffer, and showed more preference with the anterior mold half, and thus can be dry released more easily.

### Example 6

### Contact Lens Casting

A monomer mixture was prepared as in Example 4 except using 10 pbw of DMA/TRIS copolymer of Example 2. The monomer mixture was clear.

### Comparative Example 2

### Contact Lens Casting

A monomer mixture was prepared by mixing the following components, with parts by weight or parts per million designated parenthetically: V₂D₂₅ (15 pbw); TRIS-VC (55 pbw); NVP (30 pbw); n-nonanol (15 pbw); Darocur-1173 initiator (150 ppm) and IMVT (0.5 pbw). The mixture was then cast between two polypropylene mold halves and cured under UV light. All lenses stayed with the anterior molds after separating the anterior and posterior mold halves. All molds with lenses were then dried in an oven at 60° C. to reduce n-nonanol. All lenses were easily removed from the anterior mold half by dry release.

### Comparative Example 3

### Contact Lens Casting

A monomer mix was prepared by mixing the following components, with parts by weight or parts per million designated parenthetically: V₂D₉₀F₁₀ (40 pbw); TRIS-VC (55 pbw); NVP (30 pbw); Darocur-1173 initiator (0.5 pbw); and IMVT (150 ppm). The mixture was cast between two polypropylene mold halves and cured under UV light. Over 90% of lenses stayed with the anterior molds after separating the posterior and anterior mold halves. However, lenses could not be dry released from the mold half.

The monomer mixture of Comparative Example 2 illustrates a monomer mixture that can be cast into contact lenses and dry released from the mold half without the addition of the high T_{g} polymeric material. The monomer mixture of this Comparative Example 3 illustrates contact lenses that were not dry released consistently, as this second lens material had a higher silicone content and was softer, thus compromising its ability to be dry released consistently.

It will be understood that various modifications may be made to the embodiments disclosed herein. Therefore the above description should not be construed as limiting, but merely as exemplifications of preferred embodiments. Other arrangements and methods may be implemented by those skilled in the art without departing from the scope and spirit of this invention. Moreover, those skilled in the art will envision other modifications within the scope and spirit of the features and advantages appended hereto.

1. A method of making a contact lens, comprising:
adding a lens-forming mixture to a contact lens mold, said mixture comprising lens-forming monomers reactive with one another and a polymeric material not reactive with the lens-forming monomers;
copolymerizing the lens-forming monomers to form a contact lens;
releasing the contact lens from the mold; and
removing the polymeric material from the contact lens.

2. The method of claim 1, wherein the polymeric material has a glass transition temperature of at least 80° C.

3. The method of claim 1, wherein the polymeric material has a glass transition temperature of at least 100° C.

4. The method of claim 1, wherein the polymeric material forms a clear mixture when mixed with the lens-forming monomers.

5. The method of claim 4, wherein the polymeric material is soluble in the lens-forming monomers.

6. The method of claim 1, wherein the contact lens has a higher modulus prior to removal of the polymeric material than after removal of the polymeric material.

7. The method of claim 1, wherein the polymeric material is removed from the contact lens by contacting the contact lens with an organic solvent.

8. The method of claim 7, wherein the organic solvent comprises a lower alkanol.

9. The method of claim 1, wherein the lens-forming monomers include ethylenic unsaturation and are copolymerizable by free radical polymerization, and the polymeric material lacks ethylenic unsaturation.

10. The method of claim 1, wherein the lens-forming monomers comprise a hydrophilic monomer and a silicone-containing monomer.

11. The method of claim 1, wherein the lens-forming monomers comprise at least one polysiloxane-containing prepolymer endcapped with polymerizable ethylenically unsaturated radicals.

12. The method of claim 11, wherein the lens-forming monomers further comprise at least one member selected from the group consisting of methacryloxypropyl tris(trimethylsiloxy) silane and 3-[tris(trimethylsiloxy)silyl]propyl vinyl carbamate.

13. The method of claim 1, wherein the contact lens, prior to removal of the polymeric material, has a modulus of at least 3,000 g/mm², and after removal of the polymeric material, has a lower modulus.

14. The method of claim 1, wherein the polymeric material is a copolymer.

15. The method of claim 13, wherein the polymeric material is the polymerization product of a hydrophilic monomer and a silicone-containing monomer.

16. The method of claim 14, wherein the polymeric material is a copolymer of a silicone-containing monomer and a hydrophilic monomer.

17. The method of claim 1, wherein the lens-forming mixture comprises 1 to 25 weight percent of the polymeric material based on total weight of the lens-forming mixture.

18. The method of claim 16, wherein the lens-forming mixture comprises 5 to 20 weight percent.

19. The method of claim 1, wherein the contact lens is released from the mold in a dry state.

20. The method of claim 1, wherein the lens-forming monomer mixture further comprises a non-polymeric, non-reactive diluent.

21. A method of making a contact lens, comprising sequentially:
adding a lens-forming mixture to a contact lens mold, said mixture comprising lens-forming monomers reactive with one another and a polymeric material not reactive with the lens-forming monomers;
copolymerizing the lens-forming monomers to form a contact lens;
releasing the contact lens from the mold;
removing the polymeric material from the contact lens; and
hydrating, packaging and sterilizing the contact lens.

22. A method of making a contact lens, comprising sequentially:
adding a lens-forming mixture to a contact lens mold assembly comprising posterior and anterior mold halves, said mixture comprising lens-forming monomers reactive with one another and a polymeric material not reactive with the lens-forming monomers;
copolymerizing the lens-forming monomers to form a contact lens;
separating the posterior and anterior mold halves, wherein the contact lens is retained on the anterior mold half;
dry releasing the contact lens from the anterior mold half;
removing the polymeric material from the contact lens; and
hydrating, packaging and sterilizing the contact lens.
